(19) United States
(12) Patent Application Publication
(10) Pub. No.: US 2008/0206405 A1
(43) Pub. Date: Aug. 28, 2008

(54) Pet Treat Containing Organic Nutrients

(75) Inventors: Glen S. AXELROD, Colts Neck, NJ (US); Ajay GAJRIA, Monmouth Junction, NJ (US)

Correspondence Address: GROSSMAN, TUCKER, PERREAULT & PFLEGER, PLLC, 55 SOUTH COMMERICAL STREET, MANCHESTER, NH, 03101, US

(73) Assignee: T.F.H. PUBLICATIONS, INC., Neptune City, NJ (US)

(21) Appl. No.: 11/678,024

(22) Filed: Feb. 22, 2007

(51) Int. Cl. A23L 1/302; A23D 7/00

(52) U.S. Cl. 426/72; 426/601

(57) ABSTRACT

The present disclosure relates to a pet treat comprising a resin and nutritional additive wherein the nutritional additive includes an oil including one or more of a salmon oil, hemp oil and evening primrose oil. The pet treat is at least 70% organic and may be formed by melt processing techniques, such as extrusion or injection molding. The pet treat may also include a nutritional additive which may be present in particulate form wherein the particles have a size of less than or equal to about 250 microns.

### FIELD OF THE INVENTION

The present invention relates to edible treats for animals and, more particularly, to treats containing nutritional additives, and/or specific collections of nutritional additives, that may therefore improve an animal's overall health. Such nutritional additives may be in a physical form that improves their assimilation by the animal and which may therefore improve bioavailability and nutritional effect in a selected animal over a selected time period. The additives may be organic in nature, indicating that they are selected from sources that are not genetically modified and which avoid the use of pesticides and other potentially toxic treatments.

### BACKGROUND

Most dogs and other animal pets enjoy chewing on various items, and many are especially attracted to animal bones and animal-derived chew toys. A variety of products have been manufactured to provide animal pets with objects to chew or gnaw. These products are intended to provide the pet with exercise for the teeth to maintain a healthy condition satisfying a need that arose when the natural pet food, raw meat, was replaced with processed pet foods. Rawhide strips knotted on the ends to resemble bones, for example, provide abrasion for cleaning teeth by removing tartar and massaging the gums, which is not provided by the typical canine dog food.

Numerous pet chews have been developed to address the various dental and nutritional concerns. Examples of these devices include but are not limited to the following U.S. patents. These patents are commonly owned by the assignee herein: U.S. Pat. No. 5,476,069 entitled “Molded Rawhide Chew Toy”; U.S. patent application Ser. No. 08/923,070 filed Sep. 3, 1997 entitled “Vegetable Based Dog Chew now U.S. Pat. No. 6,093,427; U.S. patent application Ser. No. 08/738,423 filed Oct. 25, 1997 entitled “Edible Dog Chew” now U.S. Pat. No. 5,827,565; U.S. patent application Ser. No. 08/784,834 filed Jan. 17, 1997 entitled ‘Carrot-Based Dog Chew” now U.S. Pat. No. 5,941,197; U.S. patent application Ser. No. 09/114,872 filed Jul. 14, 1998 entitled “Heat Modifiable Edible Dog Chew” now U.S. Pat. No. 6,180,161; U.S. patent application Ser. No. 09/138,804 filed Aug. 21, 1998 entitled “Improved Edible Dog Chew” now U.S. Pat. No. 6,126,978; U.S. patent application Ser. No. 09/116,070 filed Jul. 15, 1998 entitled “Wheat & Casein Dow Chew With Modifiable Texture” now U.S. Pat. No. 6,110,521; U.S. patent application Ser. No. 09/116,555 filed Jul. 15, 1998 entitled “Heat Modifiable Peanut Dog Chew” now U.S. Pat. No. 6,093,441; U.S. patent application Ser. No. 09/227,767 filed Jan. 8, 1999 entitled “Method of Molding Edible Starch” now U.S. Pat. No. 6,159,516; and U.S. Pat. No. 6,200,616 entitled “Animal Chew”.

U.S. Pat. No. 5,407,661 entitled “Pet Chew Product Having Oral Care Properties” discloses an edible pet chew product having a flexible cellular matrix in which is contained cellulosic fibrous material such as corn cob fractions which are described as having a mechanical cleansing function when chewed by a pet.

Other earlier examples of chew products are disclosed in U.S. Pat. No. 3,871,334 to Axelrod (nylon substrate containing liquid flavor and odor components), U.S. Pat. No. 4,771,733 to Axelrod (polyurethane toy containing aqueous-based flavor and odor components), and U.S. Pat. Nos. 4,557,219 and 4,513,014 to Edwards (use of flavorings in a molded polyurethane dog chew).

### SUMMARY

In a first exemplary embodiment, the present disclosure relates to a pet treat comprising a resin and nutritional additive wherein the nutritional additive includes an oil blend comprising salmon oil, hemp oil and evening primrose oil, wherein the pet treat is at least 70% organic.

In a second exemplary embodiment, the present disclosure relates to a pet treat comprising a resin and nutritional additive wherein the nutritional additive includes an oil blend comprising salmon oil, hemp oil and evening primrose oil, wherein the salmon oil, hemp oil and evening primrose oil may be present at the following ratio: 0.1-1/0.1-1/0.1-1. The nutritional additive may be in particulate form and have a particle size of less than about 250 microns wherein the nutritional additive comprises a vitamin, mineral and phytonutrient and wherein the pet treat is at least 70% organic.

In a third exemplary embodiment the present disclosure relates to a method for extruding an edible animal treat comprising introducing a resin and nutritional additive and one or more liquids into the barrel of an extruder. The resin may be present at levels greater than about 50% by weight, and the one or more liquids may be present at levels greater than about 15% by weight. This may then be followed by mixing the resin and the one or more liquids in the barrel to form a resin composition, along with mixing in an oil blend comprising one or more of salmon oil, hemp oil and evening primrose oil. The composition may then be formed into a molded shape wherein the composition is at least 70% organic.

### DETAILED DESCRIPTION

The present invention is designed to provide additives, such as vitamins, minerals, phytonutrients, enzymes and antioxidants, which may provide functional benefits to the animal, as well as providing at least a portion of the daily recommended amounts of such ingredients, for a given pet. The additives may be targeted at specific systems within the animal's body and/or the proper functioning of those systems over a given or extended time period. Furthermore, the present invention may specifically provide such additives at particle sizes in the micron (μm) or nanometer (nm) range that may therefore enhance solubility in a given carrier, improve bioavailability, facilitate controlled release and/or protect the stability of such additives prior to digestion and release of any nutritional effect.

The additives herein may also be specifically selected such that they are organic. This may be understood as an additive that qualifies for the “FDA Organic” designation. This is therefore a reference to the feature that the additive may be produced from animals that are given no antibiotics or growth hormones. With respect to a plant source, it is reference to the feature that it is produced without using pesticides, fertilizers made with synthetic ingredients or sewage sludge, bioengineering or ionizing radiation. Organic herein therefore may be understood as mentioned, and in particular, the organic treats herein may be understood as those which are at least 70% (wt.) organic in their overall composition. Accordingly, it may be understood herein that the pet treats herein may also be at least 95% organic, as well as treats which may be 100% organic.

The present disclosure therefore provides a pet chew or treat which contains an organic content of at least about 70%. In addition, as alluded to above, the chew or treat may include such additives in a relatively small particle size. For example, 90% or more of the particles may have a particle size of less than about 250 microns (μm). In addition, the particle size may be reduced further and reside in the nanometer range, meaning the presence of 90% or more of particles having a size of less than about 100 nanometers (nm). In addition, the particle size herein may fall in the range of about 1-100 nanometers (nm), including all values and increments therein. In such manner, 90% or more of the particles may have a size between about 1-100 nanometers (nm).

The additives noted above may also be specifically combined with certain oils. In the context of the present disclosure it has been found that the additives herein may be combined with one or more of the following oils: Salmon oil, Hemp oil or Evening Primrose oil, wherein each the ratio of the weight concentrations of the oils may be 0.1-1.0/0.1-1.0/0.1-1.0, including all values and increments therein. According, with respect to the three oils, each may be present in equal amounts, or one may be present at about 10% of the level of the other, etc.

The Salmon oil herein is an oil that provides beneficial Omega-3 essential fatty acids, particularly eicosapentaenoic acid (EPA) and docosahexaneoic acid (DHA). Hemp oil is from the seed of the hemp plant that contains between 25-35% oil by weight, which is relatively high in essential fatty acids. Evening Primrose oil (EPO) is derived from the seeds of evening primrose plant also known as Oenthera biennis. EPO provides a source of the long-chain fatty acid gamma-linolenic acid (GLA), which is an all cis n−6 long-chain polyunsaturated fatty acid.

The additives herein may be dispersed in a variety of resins suitable for ingestion by an animal. Such resins may therefore include casein, starch, such as potato starch or wheat starch as well as vegetable matter, comminuted rawhide, collagen, proteins, wheat gluten, simple or complex carbohydrates, and mixtures thereof. The additives and the resin binder may then be melt processed, which may include extrusion and/or injection molding. In the case of extrusion, the ingredients may all be combined and continuously extruded into a final treat shape. In addition, pellets or granules may be formed which may then be utilized for injection molding. Moreover, the extrusion process may lead to the formation of sheet material which may also be used to cut and form a desired treat configuration. In addition, it is contemplated herein that one may utilize rotational molding as well as compression molding to form a give treat product.

With respect to injection molding, the treats herein may be manufactured by a process of direct injection molding, and reference is next made to U.S. patent application Ser. No. 11/198,881 filed Aug. 5, 2005 entitled “Direct Starch Molding” and U.S. application Ser. Nos. 11/251,261 and 11/278,735 filed respectively on Oct. 14, 2005 and Apr. 5, 2006 entitled “Direct Melt Processing Of Resins”, all commonly assigned to the assignee of the present invention and included herein in their entirety by reference. These disclosures recite a direct injection molding process where the ingredients are mixed in the barrel of the machine and injected into a closed mold and allowed to harden.

In a first exemplary embodiment, the molded edible organic animal treat may include a resin, such a starch, and liquids, such as a plasticizer and water. The starch composition may include any carbohydrate of natural or vegetable origin. The starch may include amylose and/or amylopectin and may be extracted from plants, including but not limited to potatoes, rice, tapioca, corn and cereals such as rye, wheat, and oats. The starch may also be extracted from fruits, nuts and rhizomes, or arrowroot, guar gum, locust bean, arracacha, buckwheat, banana, barley, cassaya, konjac, kudzu, oca, sago, sorghum, sweet potato, taro, yams, fava beans, lentils and peas. The starch may be present between about 30-99% including all increments and values therebetween such as levels above about 50%, 85%, etc.

The starch employed herein may be raw starch, which may be understood as starch that has not seen a prior thermal molding history, such as extrusion or other type of melt processing step. The raw starch itself may also be native, which may be understood as unmodified starch recovered in the original form by extraction and not physically or chemically modified. The raw starch may also be in powder form of varying particle size, which may be understood as milled and/or pre-sifted. It should be understood that the raw starch may also have varying degrees moisture present.

The starch composition may include cellulose. The cellulose may be, for example, a long-chain polymer of polysaccharide carbohydrate. The cellulose may also be derived or extracted from plants. The cellulose may be incorporated into the starch composition between about 1-15% by weight of the starch composition and any increment or value therebetween including 4%, 10%, 11%, etc.

Emulsifiers or surfactants may also be incorporated into the starch composition. The emulsifier may be present between about 1-10% by weight of the starch composition and all increments or values therebetween including 3%, 4%, etc. The emulsifier may include, for example, lecithin, which may be extracted or derived from, for example, egg yolk or soy beans.

The starch composition may also include a plasticizer. The plasticizer may include for example, glycerin. The plasticizer may be incorporated between about 15-30%, including all increments and values therebetween such as levels greater than 15%, 21%, 27% etc.

A humectant may also be incorporated into the starch composition. The humectant may include, for example, oat fiber. The humectant may be incorporated between about 0.1-5% by weight of the starch composition including all intervals and values therebetween, including 1%, 25%, etc. A humectant may be understood to be any additive that may absorb water in the material.

The starch composition may also include water. The water may be introduced into the composition between about 1-40% by weight of the starch composition and any increment or value therebetween, including 4%, 20-40%, 10-20%, etc. After the product has been formed, the water may be present between about 1-20% by weight of the starch composition including all increments or values therebetween, such as, below 20%, 4%, 5-10%, etc.

The starch composition may further include a nutraceutical. The nutraceutical may be fermented soya. Fermented soya nutraceuticals are available from Bio Food, Ltd., Pine Brook, N.J. and sold under the general trademark Soynatto®. The fermented soya is present between about 1-40% by weight of the starch composition, including all increments and values therebetween, including 10%, 20%, etc.

The Soynatto® product may provide proteins, minerals, and vitamins, in a fermented soy form. The fermentation process may infuse the product with saccharomyces cerevisiae, commonly known as “bakers yeast” or “brewers yeast.” Saccharomyces cerevisiae is more traditionally known to ferment sugars present in flour or dough, yielding carbon dioxide and alcohol. Accordingly, it should be appreciated that a protein, one or more of a mineral, and one or more of a vitamin, along with saccharomyces cerevisiae may be present in the starch composition.

The fermented soy product herein may include increased concentrations of glycitein, daidzein and genistein, reportedly present at several hundred percent more than other more common soyfood sources. Glycitein, daidzein and genistein belong to the isoflavone class of flavanoids and may be classified as phytoestrogen, since they are plant derived nonsteriodal compounds that contain estrogen-like biological activity.

Other additives may be introduced into the composition. These additives may include vegetable matter, fruit matter, rawhide, nuts, nut bits or nut flour such as peanut flour, and animal or fish products, by-products, meal or digests, etc. Glutens may also be incorporated into the starch composition. Gluten may be understood as water-insoluble protein complex extracted from cereal grains such as maize or corn and wheat. These additives may be present individually or cumulatively between about 0.1-50% by weight of the starch composition and all increments and values therebetween including 0.1-5.0%, 15%, 25%, etc.

Additionally, flavorants, herbs, herbal extracts, vitamins, minerals, colorants, yeast products, soy products, attractants, etc, may be incorporated into the starch composition. Yeast products may include nutritional yeast or brewers yeast such as saccharomyces cerevisiae, dairy yeast such as kluyveromyce marxianus or wine yeast such as saccharomyces fermentati. The soy products may include fermented soy or other soy products, as listed in the table above. Attractants may include compounds listed herein, such as the animal or fish digests, or other compounds that may increase an animal's interest in the starch composition. These additives may be present individually or cumulatively between about 0.01-25% by weight of the starch composition and any increment or value therebetween including 0.01-0.5%, 10%, 20%, etc. The composition may also include calcium carbonate. The calcium carbonate may be present between about 5-10%.

Organic based trace minerals which may be used in the molded treats of the present invention may include amino acid complexes, amino acid metal chelates, polysaccharide compounds and proteinates. Metal chelates herein may be understood as a metal which has formed a complex in which the metal is ionized (metal ion) and bound to two or more atoms (the chelating agent). The bonds themselves may be any combination of coordination or ionic bonds.

Mineral proteinates are minerals bound to small proteins or amino acids. By grinding or milling such proteinates to a particle size wherein about 90% is of a particle size less than 250 microns, or 90% is of a particle size of less than 100 nanometers, zinc, copper, cobalt and other minerals may be made available which may be made to correct daily deficiencies in an animals diet. These metal proteinates are reportedly more bioavailable than the aforementioned sources of minerals and may be more easily dispersed or dissolved.

The present invention also contemplates the use of phytonutrients or phyto-chemicals as important ingredients in molded organic animal treats to provide functional benefits to the animal. Phytonutrients are defined as any nutrient or chemical derived from a plant source. Such phytonutrients may include terpenes, including carotenoids and limonoids, as well as phytosterols, phenols, thiols and isothiocyanates, saponins, capsaicinoids, organosulfurs, indoles, isoprenoids, tocotrienols, tocopherols, lipoic acid and ubiquinone. Carotenoids may comprise carotenes (for instance beta- and gamma-, as well as lycopene and lutein) and xanthophylls. The carotenes reportedly possess vitamin A activity and offer protection against a variety of cancers, as well as enhancing immune response. Xanthophylls reportedly protect vitamins and other carotenoids from oxidation. Liminoids may be specific chemopreventive agents. Phytostreols may block the uptake of cholesterol and reportedly may block the development of tumors. Phenols, such as from blue, red-blue and violet berries, are reportedly a disease preventive and may block enzymes that may cause inflammation. Flavonoids are one type of phenol that may enhance the effects of vitamin C. Flavanoids may include, but not be limited to, flavones, flavonols and flavonones which reportedly protect the vascular system and act to reduce allergies, inflammation, viruses and tumors. Flavonols reportedly strengthen the intertwined strands of collagen protein. Anthocyanidins, a type of flavonol may scavenge free radicals. Catechins and gallic acids are a type of flavonoid that reportedly have chemoprotective properties. Isoflavonoes reportedly block enzymes that promote tumor growth. Glucosinolates and allyl sulfides, both types of thiol phytonutrients, reportedly possess antimutagenic and anticarcinogenic properties as well as immune and cardiovascular protection in humans. Indoles interact with vitamin C and may bind carcinogens and enzymes. Isoprenoids neutralize free radicals. Lipoic acid and ubiquinone may act as antioxidants to extend the effects of other antioxidants.

Food sources containing phytonutrients include: (carotenoids) yellow-orange fruits and vegetables: carrots, cantaloupe, papaya, pumpkin, squash, sweet potatoes, broccoli, dried apricots, asparagus, kale, green leafy vegetables, peppers; (lycopenes) tomatoes, tomato paste, tomato juice, guava, pink grapefruit, watermelon; (beta cryptozanthin) tangerines, papaya, oranges, peaches, mangoes, nectarines; (flavonoids) soy, green tea, tomatoes, sweet potatoes, cruciferous vegetables such as broccoli, cabbage, brussels sprouts, mustard greens, kale, and cauliflower, citrus fruits, red wine, red grapes, onions; (indoles) cruciferous vegetables; (sulforaphane) cruciferous vegetables; (isoflavones) legumes (beans, peas, lentils), soy products; (allicin) garlic, onions; (genistein) soy products (e.g., tofu); (polyphenols) green tea; (anthocyanins) wild blueberries, bilberries, black berries; (limonoids) citrus fruits; (sterols) cruciferous vegetables, cucumbers, squash, sweet potatoes, soy foods, eggplant, whole grains, tomatoes; (capsaicin) chili peppers; (elegiac acid) strawberries; (lignans) nuts and seeds.

Other sources of important nutrients for animals may include seaweed, kelp, blue green algae, spirulina, irish moss, dulse, nori, kombu, wakeme, alfalfa, fenugreel seed, wheatgrass, barleygrass and marine phytoplankton.

It is further contemplated that the edible natural molded treats or chews of the present invention may include chondroitin and glucosamine which may help to build healthy, smooth joints.

The processes consistent with the present invention may therefore be used for manufacturing edible molded organic animal treats and/or edible animal chews. Animal treats consistent with the present invention are intended to be fully consumed by a pet or animal. As such, when the desired product is an animal treat it may also be formed from one or more of all of the previously mentioned ingredients providing nutritional benefits. Similarly, animal chews consistent with the present invention may be intended to provide nutritional value and may also provide functional health benefits that may serve to improve the life and longevity of the animal.

Furthermore, it should also be understood by those having skill in the art, however, that any classification of “treat” or “chew” or “chew toy” as used herein has no bearing on the scope of the invention herein. In addition, it must also be noted that the concept of animal treat or chew herein is not limited and may extend to birds, small mammals, etc.

The following non-limiting examples illustrate various features of the disclosure noted above.

### EXAMPLE 1

### Nutritional Formulation—To Improve Skin & Coat

Ingredients: Organic Barley, Organic Oats, Organic Rice, Organic Chicken, Organic Flax Seed, Organic Canola Oil, Natural Flavor, Organic Peas, Organic Carrots, Fish Meal, Oil Blend (Salmon, Hemp & Evening Primrose), Vitamin E Supplement, Lecithin, Zinc Methionine Complex (Source of Chelated Zinc), (Choline Chloride, Iron Amino Acid Complex (Source of Chelated Iron), Rosemary Extract, Manganese Amino Acid Complex (Source of Chelated Manganese), Lecithin, Copper Amino Acid Complex (Source of Chelated Copper), Vitamin B12 Supplement, Vitamin A Acetate, Niacin, Calcium Pantothenate, Vitamin D3 Supplement, Ascorbic Acid (Source of Vitamin C), Riboflavin, Folic Acid, Pyridoxine Hydrochloride, Thiamin Hydrochloride, Biotin, Cobalt Proteinate (Source of Chelated Cobalt), Ethylenediamine Dihydriodide (Source of Iodine), Sodium Selenite.

The above formulation provides a minimum crude protein of about 13%, a minimum crude fat of about 11.5%, a maximum crude fiber of about 8.5%, a maximum moisture of about 10.0%, Omega 3 Fatty Acids at about 0.50%, Omega 6 Fatty Acids at about 2.20%. The organic percentage is at about 95.0%.

### EXAMPLE II

### Multi-Vitamin Formulation

Ingredients: Organic Barley, Organic Oats, Organic Rice, Organic Chicken, Organic Flax Seed, Organic Canola Oil, Natural Flavor, Organic Peas, Organic Carrots, Fish Meal, Oil Blend (Salmon, Hemp & Evening Primrose), Vitamin E Supplement, Calcium Carbonate, Zinc Methionine Complex (Source of Chelated Zinc), Choline Chloride, Iron Amino Acid Complex (Source of Chelated Iron), Rosemary Extract, Manganese Amino Acid Complex (Source of Chelated Manganese), Lecithin, Copper Amino Acid Complex (Source of Chelated Copper), Vitamin B12 Supplement, Vitamin A Acetate, Niacin, Calcium Pantothenate, Vitamin D3 Supplement, Ascorbic Acid (Source of Vitamin C), Riboflavin, Folic Acid, Pyridoxine Hydrochloride, Thiamin Hydrochloride, Biotin, Cobalt Proteinate (Source of Chelated Cobalt), Ethylenediamine Dihydriodide (Source of Iodine), Sodium Selenite.

The above formulation provides a minimum crude protein of about 13%, a minimum crude fat of about 11.5%, a maximum crude fiber of about 8.5%, a maximum moisture of about 10.0%. The organic percentage is at about 95.0%.

### EXAMPLE III

### Immune Boosting Composition

Ingredients: Organic Barley, Organic Oats, Organic Rice, Organic Chicken, Organic Flax Seed, Organic Canola Oil, Natural Flavor, Organic Peas, Organic Carrots, Fish Meal, Oil Blend (Salmon, Hemp & Evening Primrose), Vitamin E Supplement, Calcium Carbonate, Barley Grass, Blueberries, Vitamin C, Parsley, Zinc Methionine Complex (Source of Chelated Zinc), (Choline Chloride, Iron Amino Acid Complex (Source of Chelated Iron), Rosemary Extract, Manganese Amino Acid Complex (Source of Chelated Manganese), Lecithin, Copper Amino Acid Complex (Source of Chelated Copper), Vitamin B12 Supplement, Vitamin A Acetate, Niacin, Calcium Pantothenate, Vitamin D3 Supplement, Ascorbic Acid (Source of Vitamin C), Riboflavin, Folic Acid, Pyridoxine Hydrochloride, Thiamin Hydrochloride, Biotin, Cobalt Proteinate (Source of Chelated Cobalt), Ethylenediamine Dihydriodide (Source of Iodine), Sodium Selenite.

The above formulation provides a minimum crude protein of about 13%, a minimum crude fat of about 11.5%, a maximum crude fiber of about 8.5%, a maximum moisture of about 10.0%. The organic percentage is at about 95.0%.

### EXAMPLE IV

### Joint Treatment Formulation

Ingredients: Organic Barley, Organic Oats, Organic Rice, Organic Chicken, Organic Flax Seed, Organic Canola Oil, Natural Flavor, Organic Peas, Organic Carrots, Fish Meal, Oil Blend (Salmon, Hemp, Evening Primrose), Calcium Carbonate, Vitamin E Supplement, Glucosamine, Green Lipped Mussels, Chondroitin, Zinc Amino Acid Complex (Source of Chelated Zinc), Choline Chloride, Iron Amino Acid Complex (Source of Chelated Iron), Rosemary Extract, Manganese Amino Acid Complex (Source of Chelated Manganese), Lecithin, Copper Amino Acid Complex (Source of Chelated Copper), Vitamin B 12 Supplement, Vitamin A Acetate, Niacin, Calcium Pantothenate, Vitamin D3 Supplement, Ascorbic Acid (Source of Vitamin C), Riboflavin, Folic Acid, Pyridoxine Hydrochloride, Thiamin Hydrochloride, Biotin, Cobalt Proteinate (Source of Chelated Cobalt), Ethylenediamine Dihydriodide (Source of Iodine), Sodium Selenite.

The above formulation provides a minimum crude protein of about 13%, a minimum crude fat of about 12.0%, a maximum crude fiber of about 8.5%, a maximum moisture of about 10.0%. In addition, the formulation contains a minimum of about 400 mg/kg of glucosamine and a minimum of about 200 mg/kg of chondroitin. The organic percentage is again at about 95%.

### EXAMPLE V

### Puppy Treat Formulation

Ingredients: Organic Barley, Organic Oats, Organic Rice, Organic Chicken, Organic Flax Seed, Organic Canola Oil, Natural Flavor, Calcium Carbonate, Organic Peas, Organic Carrots, Fish Meal, Oil Blend (Salmon, Hemp & Evening Primrose), Vitamin E Supplement, Arginine, Taurine, Calcium Amino Acid Chelate (Source of chelated calcium), Choline Chloride, Zinc Amino Acid Complex (Source of Chelated Zinc), Iron Amino Acid Complex (Source of Chelated Iron), Rosemary Extract, Manganese Amino Acid Complex (Source of Chelated Manganese), Lecithin, Copper Amino Acid Complex (Source of Chelated Copper), Vitamin B 12 Supplement, Vitamin A Acetate, Niacin, Calcium Pantothenate, Vitamin D3 Supplement, Ascorbic Acid (Source of Vitamin C), Riboflavin, Folic Acid, Pyridoxine Hydrochloride, Thiamin Hydrochloride, Biotin, Cobalt Proteinate (Source of Chelated Cobalt), Ethylenediamine Dihydriodide (Source of Iodine), Sodium Selenite.

The above formulation provides a minimum crude protein of about 14%, a minimum crude fat of about 11.5%, a maximum crude fiber of about 8.5%, a maximum moisture of about 10.0%. In addition, it provides a minimum calcium level of about 0.9% and a maximum calcium level of about 1.9%. The organic percentage is again at about 95%.

This invention has been set forth in detail, but it should be understood by those skilled in the art that the various examples herein are by way of illustration only and the features of each example or embodiment may be interchanged. Modifications and variation will therefore be apparent and may be resorted to without departing from the spirit and equivalent scope of this invention. Accordingly, such modifications and equivalents are considered to be within the purview of the scope of the invention as set forth in the following claims.

What is claimed is:

1. A pet treat comprising a resin and nutritional additive wherein said nutritional additive includes an oil blend comprising salmon oil, hemp oil and evening primrose oil, wherein said pet treat is at least 70% organic.

2. The pet treat of claim 1 wherein the salmon oil, hemp oil and evening primrose oil are present at the following ratio: 0.1-1/0.1-1/0.1-1.

3. The pet treat of claim 1 wherein said nutritional additive is in particulate form and has a particle size of less than about 250 microns.

4. The pet treat of claim 1 wherein said nutritional additive is in particulate form and has a particle size of less than about 100 nanometers.

5. The pet treat of claim 1 wherein said nutritional additive comprises one or more of a vitamin, mineral and phytonutrient.

6. The pet treat of claim 1 wherein said nutritional additive comprises one or more of chondroitin and/or glucosamine, omega fatty acid, cellulose, gluten and calcium carbonate.

7. The pet treat of claim 1 wherein said nutritional additive comprises a fermented soya.

8. The pet treat of claim 1 wherein said nutritional additive comprises one or more metal chelate compounds.

9. A pet treat comprising a resin and nutritional additive wherein said nutritional additive includes an oil blend comprising salmon oil, hemp oil and evening primrose oil, wherein the salmon oil, hemp oil and evening primrose oil are present at the following ratio: 0.1-1/0.1-1/0.1-1, wherein the nutritional additive is in particulate form and has a particle size of less than about 250 microns and wherein the nutritional additive comprises on of a vitamin, mineral and phytonutrient, wherein said pet treat is at least 70% organic.

10. The pet treat of claim 9 wherein said nutritional additive is in particulate form and has a particle size of less than about 100 nanometers.

11. The pet treat of claim 9 wherein said nutritional additive comprises a vitamin, mineral and phytonutrient.

12. The pet treat of claim 9 wherein said nutritional additive comprises one or more of chondroitin and/or glucosamine, cellulose, gluten and calcium carbonate.

13. The pet treat of claim 9 wherein said nutritional additive comprises one or more metal chelate compounds.

14. A method for extruding an edible animal treat comprising
introducing a resin and nutritional additive and one or more liquids into the barrel of an extruder, wherein said resin is present at levels greater than about 50% by weight, and said one or more liquids is present at levels greater than about 15% by weight;
mixing said resin and said one or more liquids in said barrel to form a resin composition;
mixing in an oil blend comprising one or more of salmon oil, hemp oil and evening primrose oil;
forming said resin composition into a molded shape
wherein said composition is 95% organic.

15. The method of claim 1 wherein said nutrient is in particulate form wherein said particles are at a size of less than about 250 microns.

16. The method of claim 14 wherein the salmon oil, hemp oil and evening primrose oil are all present at a selected weight percent, and are at the following ratio relative to one another with respect to said weight percent: 0.1-1/0.1-1/0.1-1.

17. The method of claim 14 wherein said nutritional additive comprises one or more of chondroitin and/or glucosamine, cellulose, gluten and calcium carbonate.

18. The method of claim 14 wherein said nutritional additive comprises a fermented soya.

19. The method of claim 14 wherein said nutritional additive comprises one or more metal chelate compounds.

20. The method of claim 14 wherein said nutritional additive is in particulate form and has a particle size of less than about 100 nanometers.
